(19) United States
(12) Patent Application Publication
(10) Pub. No.: US 2024/0034679 A1
(43) Pub. Date: Feb. 1, 2024

(54) ECOLOGICALLY ENHANCED ECO-TILE AND METHOD OF PRODUCTION

(71) Applicants: City University of Hong Kong, Hong Kong (CN); The Hong Kong Polytechnic University, Hong Kong (CN)

(72) Inventors: Kenneth Mei Yee LEUNG, Hong Kong (CN); Chi-sun POON, Hong Kong (CN); Juan Carlos ASTUDILLO PLACENCIA, Hong Kong (CN)

(21) Appl. No.: 17/814,863

(22) Filed: Jul. 26, 2022

(51) Int. Cl. C04B 28/04; C04B 18/04; C04B 18/10; C04B 14/06; C04B 20/00; C04B 24/20; C04B 28/28; C04B 24/26

(52) U.S. Cl. CPC C04B 28/04; C04B 18/0436; C04B 18/106; C04B 14/06; C04B 20/0016; C04B 24/20; C04B 28/28; C04B 24/267; C04B 2103/32

(57) ABSTRACT

An eco-tile useful for promoting the growth of fauna and flora in an aquatic environment, the eco-tile including at least one type of cement; aggregates comprising at least two fine aggregates and coarse aggregates; and milled incineration sewage sludge ashes, wherein the at least two fine aggregates comprise dredged marine sediment, eco-concrete precursors thereof, and methods of use and preparation of the same.

### TECHNICAL FIELD

The present disclosure relates to concrete substrates useful for promoting the growth of fauna and flora in an aquatic environment, eco-concrete precursors thereof, and methods of use and preparation of the same.

### BACKGROUND

In contrast to natural shorelines, conventional artificial seawalls are characterized by a lack of habitat complexity (i.e., simple and homogenous granite or concrete surfaces) and unsuitable material composition (e.g., concrete with high pH of 12-13 and high carbon footprint) to sustain marine biodiversity and promote sustainable development.

Current artificial seawalls usually have simple homogenous granite or concrete surfaces, which lack the diverse microhabitats, such as crevices, holes, surface texture and water retention for both marine fauna and flora that natural seawall surfaces exhibit. An additional shortcoming of current artificial seawalls is they tend to have pH, usually in the range of 12-13, which is much higher than the pH of natural seawater (around pH 8) and can negatively impact the growth of certain organisms.

There thus exists a need to develop improved eco-tiles useful for providing artificial marine habitats capable of supporting increased biodiversity that addresses at least some of the disadvantages described above.

### SUMMARY

Provided herein is an ecologically friendly concrete mixture that incorporates waste materials to promote waste recycling and reduce carbon footprint. The composition and production method of the concrete mixture provides an eco-concrete with low pH suitable for facilitating settlement of marine organisms and sustaining their survival. The eco-concrete can be used to fabricate an ecologically engineered eco-tile that integrates ecological principles with diverse microhabitats, such as crevices, holes, surface texture and water retention for both marine fauna and flora. The eco-tile described herein has a reduced carbon footprint and low surface pH, while it comprises a variety of microhabitats for the settlement of marine species. These microhabitats effectively provide predation refuges and temperature and desiccation shelters to intertidal species compared to conventional concrete seawalls. In turn, the eco-tile can increase marine biodiversity as well as the ecosystem's functions and services.

In a first aspect, provided herein is an eco-tile comprising: at least one type of cement; aggregates comprising at least two fine aggregates and coarse aggregates; and milled incineration sewage sludge ashes (MISSA), wherein the at least two fine aggregates comprise dredged marine sediment (MSD).

In certain embodiments, a surface of the eco-tile has a pH less than 11.

In certain embodiments, a surface of the eco-tile has a pH between 9-10.5.

In certain embodiments, the eco-tile has a compressive strength 35-45 Mpa.

In certain embodiments, the at least one type of Type I Ordinary Portland Cement, Type II Modified or Blended Portland Cement, Type III Rapid Hardening Portland Cement, Type IV Low Heat Portland Cement, Type V, Sulphate-Resisting Portland Cement, or a combination thereof.

In certain embodiments, the at least two fine aggregates comprise sand.

In certain embodiments, the coarse aggregates comprise gravel.

In certain embodiments, the MISSA and the at least one type of cement are present in the eco-tile at a mass ratio of at least 1:4, respectively.

In certain embodiments, the MSD and each of the other fine aggregates present in the at least two fine aggregates are present in the eco-tile at a mass ratio of at least 1:4, respectively.

In certain embodiments, the MSD and each of the other fine aggregates present in the at least two fine aggregates are present in the eco-tile at a mass ratio of 1:4 to 2:3, respectively.

In certain embodiments, the eco-tile further comprises at least one superplasticizer selected from the group consisting of a poly(melamine sulfonate), a poly(naphthalene sulfonate), polycarboxylate, a diphosphonate terminated polyoxyethylene, and salts thereof.

In certain embodiments, at least one surface of the eco-tile is defined by a plurality of microhabitat forming features selected from the group consisting of crevices, fissures, tunnels, holes, and irregular surface features of the eco-tile surface.

In certain embodiments, the eco-tile comprises: ordinary Portland cement; aggregates comprising MSD, sand, and gravel; MISSA; and at least one superplasticizer selected from the group consisting of a poly(melamine sulfonate), a poly(naphthalene sulfonate), polycarboxylate, a diphosphonate terminated polyoxyethylene, and salts thereof, wherein the ordinary Portland cement and the MISSA are present in the eco-tile at a mass ratio of at least 1:4, respectively; the MSD and the sand are present in the eco-tile at a mass ratio of 1:4 to 2:3, respectively; and at least one surface of the eco-tile is defined by a plurality of microhabitat forming features selected from the group consisting of crevices, fissures, tunnels, holes, and irregular surface features of the eco-tile surface.

In certain embodiments, a surface of the eco-tile has a pH between 9-10.5.

In certain embodiments, the eco-tile has a compressive strength 35-45 Mpa.

In a second aspect, provided herein is a method of promoting the growth of fauna and flora in an aquatic environment comprising placing at least one eco-tile of the first aspect in the aquatic environment.

In certain embodiments, promoting the growth of fauna and flora comprises the recruitment of 16 to 35 species per 25 cm×25 cm area of eco-tile after 12 months of deployment in the aquatic environment.

In a third aspect, provided herein is an eco-concrete mixture comprising: at least one type of cement; aggregates comprising at least two fine aggregates and coarse aggregates; at least one superplasticizer; milled incineration sewage sludge ashes (MISSA); and water, wherein the at least two fine aggregates comprise dredged marine sediment (MSD).

In certain embodiments, the at least one type of cement is ordinary Portland cement; the aggregates comprise MSD, sand, and gravel; and the at least one superplasticizer is selected from the group consisting of a poly(melamine sulfonate), a poly(naphthalene sulfonate), polycarboxylate, a diphosphonate terminated polyoxyethylene, and salts thereof.

In certain embodiments, the ordinary Portland cement, MISSA, MSD, gravel, sand, at least one superplasticizer, and water are present in the eco-concrete mixture in a 10-20 wt %, 2-7 wt %, 5-20 wt %, 30-50 wt %, 20-30 wt %, 0.01-0.5 wt %, or 5-10 wt %, respectively.

In certain embodiments, the ordinary Portland cement, MISSA, MSD, gravel, sand, at least one superplasticizer, and water are present in the eco-concrete mixture in a 12-16 wt %, 2-4 wt %, 6-14 wt %, 35-45 wt %, 20-27 wt %, 0.03-0.07 wt %, or 7-10 wt %, respectively.

### BRIEF DESCRIPTION OF THE DRAWINGS

The above and other objects and features of the present disclosure will become apparent from the following description of the disclosure, when taken in conjunction with the accompanying drawings.

FIG. 1 depicts the casting of eco-tiles in accordance with certain embodiments described herein.

FIG. 2 depicts the final eco-tile after demoulding and curing in accordance with certain embodiments described herein.

FIG. 3 depicts the Surface pH values of eco-tiles before and after 12 months of deployment in Sai Kung, Hong Kong. M1=MISSA, M1+C=carbonated MISSA, OPC=ordinary Portland cement and OPC+C=carbonated OPC.

FIG. 4 depicts scanning electron microscope (SEM) images of eco-tiles A) M1, B) M1+C, C) OPC and D) OPC+C.

FIG. 5 depicts mean surface temperature (° C.) of eco-tiles in A) Sai Kung, B) Lung Kwu Tan and C) Ma Liu Shui, Hong Kong after 12 months of deployment. Error bars represent ±95% confidence intervals. M1=MISSA, M1+C=carbonated MISSA, OPC=ordinary Portland cement and OPC+C=carbonated OPC.

FIG. 6 depicts the list of epibiota species found at the eco-tile trial site in Sai Kung after 12 months of deployment. M1=MISSA, M1+C=carbonated MISSA, OPC=ordinary Portland cement and OPC+C=carbonated OPC. Dark grey cells indicate species only found in one type of eco-tile, grey cells species only found in eco-tiles and light grey cells species only found in control seawall.

FIG. 7 depicts the list of epibiota species found at the eco-tile trial site in Lung Kwu Tan after 12 months of deployment. M1=MISSA, M1+C=carbonated MISSA, OPC=ordinary Portland cement and OPC+C=carbonated OPC. Dark grey cells indicate species only found in one type of eco-tile, grey cells species only found in eco-tiles.

FIG. 8 depicts list of epibiota species found at the eco-tile trial site in Ma Liu Shui after 12 months of deployment. M1=MISSA, M1+C=carbonated MISSA, OPC=ordinary Portland cement and OPC+C=carbonated OPC. Dark grey cells indicate species only found in one type of eco-tile, grey cells species only found in eco-tiles and light grey cells species only found in control seawall.

FIG. 9 depicts charts showing the mean species richness on tiles, control and reference plots at A) Sai Kung, B) Lung Kwu Tan and C) Ma Liu Shui after 12 months of deployment. Error bars indicate ±95% confidence intervals

FIG. 10 depicts charts showing the abundance of mobile species (ind./m²) on tiles, control plots and reference plots at A) Sai Kung, B) Lung Kwu Tan and C) Ma Liu after 12 months of deployment. Composition based on main taxa and functional feeding groups are indicated for each site. Dotted line separates the different habitats within each trial site. Error bars indicate ±95% confidence intervals.

FIG. 11 depicts charts showing the percentage coverage of main taxonomic groups on eco-tiles and control plots and reference plots at A) Sai Kung, B) Lung Kwu Tan and C) Ma Liu Shui after 12 months of deployment using the photoquadrat method. Dotted lines separate the different habitats within each trial site.

FIG. 12 depicts charts showing the percentage coverage of fauna on eco-tiles, control plots and reference plots at A) Sai Kung, B) Lung Kwu Tan and C) Ma Liu Shui after 12 months of deployment using the photoquadrat method. Dotted lines separate the different habitats within each trial site. Error bars indicate ±95% confidence intervals.

FIG. 13 depicts a view of an ecologically enhanced substrate comprising a plurality of crevices, grooved surfaces holes, and surface texture in accordance with certain embodiments described herein.

### DETAILED DESCRIPTION

### Definitions

Throughout the application, where compositions are described as having, including, or comprising specific components, or where processes are described as having, including, or comprising specific process steps, it is contemplated that compositions of the present teachings can also consist essentially of, or consist of, the recited components, and that the processes of the present teachings can also consist essentially of, or consist of, the recited process steps.

In the application, where an element or component is said to be included in and/or selected from a list of recited elements or components, it should be understood that the element or component can be any one of the recited elements or components, or the element or component can be selected from a group consisting of two or more of the recited elements or components. Further, it should be understood that elements and/or features of a composition or a method described herein can be combined in a variety of ways without departing from the spirit and scope of the present teachings, whether explicit or implicit herein.

It should be understood that the order of steps or order for performing certain actions is immaterial so long as the present teachings remain operable. Moreover, two or more steps or actions may be conducted simultaneously.

The use of the singular herein includes the plural (and vice versa) unless specifically stated otherwise. In addition, where the use of the term “about” is before a quantitative value, the present teachings also include the specific quantitative value itself, unless specifically stated otherwise. As used herein, the term “about” refers to a ±10%, ±7%, ±5%, ±3%, ±1%, or ±0% variation from the nominal value unless otherwise indicated or inferred.

The present disclosure provides an eco-tile comprising: at least one type of cement; aggregates comprising at least two fine aggregates and coarse aggregates; and milled incineration sewage sludge ashes (MISSA), wherein the at least two fine aggregates comprise dredged marine sediment (MSD).

The at least one cement can be any cement known in the art. Exemplary cements, include, but are not limited to, Type I Ordinary Portland Cement, Type II Modified or Blended Portland Cement, Type III Rapid Hardening Portland Cement, Type IV Low Heat Portland Cement, Type V Sulphate-Resisting Portland Cement, blast furnace slag cement, high alumina cement, white cement, colored cement, air entraining cement, expansive cement, hydrographic cement, or other types of cement, or combinations thereof. Additional exemplary cements include calcium aluminate cements, plaster materials, silicate cements, gypsum cements, phosphate cements, and cements based on magnesium oxychloride. In certain embodiments, the cement is ordinary Portland cement.

There are no particular requirements for fine aggregates. Most types of fine aggregate can be used for the preparation of the eco-tiles described herein. Exemplary fine aggregates include, but are not limited to coral sand, glass sand, immature sand, gypsum sand, ooid sand, silica sand, pit sand, river sand, sea sand, green sand, desert sand, lithic sand, mixed carbonate-silicate sand, biogenic sand, garnet sand, olivine sand, volcanic sand, heavy mineral sand, continental sand, quartz sand, clay, silt, fine sand, medium sand, coarse sand, stone dust, MSD, recycled fine aggregate derived from demolition waste or any of the materials listed for coarse aggregate that have been ground/pulverized into fine particles, and combinations thereof. In certain embodiments, fine aggregate can comprise two types of aggregates (e.g., river sand and MSD with a required proportion).

The coarse aggregate can be coarse gravel, medium gravel, fine gravel, crushed rock, pebbles, stones, recycled concrete rubbles, river gravel, sea gravel, crushed glass, slate waste, waste plastics, recycled coarse aggregate derived from demolition waste and combinations thereof.

The terms “fine aggregate” and “coarse aggregate” used herein are not intended to limit a range of sizes, but are simply used to indicate that one type of aggregate contains larger particles than the other type. For example, in a cement mixture containing two types of fine sand, the fine sand with larger particles will be called coarse aggregate.

The fine aggregates can have a particle size less than 10 mm, less than 5 mm, or less than 2 mm. In certain embodiments, fine aggregates have a particle size less than 5 mm and less than 2 mm.

The coarse aggregates can have a particle size less than 50 mm, less than 45 mm, less than 40 mm, less than 35 mm, less than 30 mm, less than 25 mm, less than 20 mm, less than 15 mm, less than 16 mm, or less than 10 mm. In certain embodiments, the coarse aggregates have a particle size between 5-10 mm or 2-8 mm.

A portion of the at least one cement can be replaced with MISSA. In certain embodiments, between 1-60% by weight, 5-60% by weight, 5-55% by weight, 5-50% by weight, 5-45% by weight, 5-50% by weight, 5-45% by weight, 5-40% by weight, 5-35% by weight, 5-30% by weight, 10-30% by weight, 10-25% by weight, 15-25% by weight, or 18-22% by weight, of the at least one cement is replaced with MISSA. In certain embodiments, about 20% by weight of the at least one cement is replaced with MISSA.

The MSD and each of the other fine aggregates present in the at least two fine aggregates can be present in the eco-tile at a ratio of at least 5:95, at least 1:9, at least 3:17, at least 1:4, at least 1:3, at least 3:7, at least 2:3, at least 1:9, at least 3:2, at least 7:3, respectively. In certain embodiments, the MSD and each of the other fine aggregates present in the at least two fine aggregates can be present in the eco-tile at a ratio of 5:95 to 7:3, 1:9 to 3:2, 1:9 to 1:1, 1:4 to 1:1, or 1:4 to 2:3, respectively. In certain embodiments, the MSD and each of the other fine aggregates present in the at least two fine aggregates can be present in the eco-tile at a ratio of about 1:4 or about 2:3, respectively.

The MISSA and the at least one type of cement can be present in the eco-tile at a mass ratio of at least 5:95, at least 1:9, at least 3:17, at least 1:4, at least 1:3, at least 3:7, at least 2:3, at least 1:9, at least 3:2, at least 7:3, respectively. In certain embodiments, the MISSA and the at least one type of cement can be present in the eco-tile at a mass ratio of 5:95 to 7:3, 1:9 to 3:2, 1:9 to 1:1, 1:4 to 1:1, or 1:4 to 2:3, respectively. In certain embodiments, the MISSA and the at least one type of cement can be present in the eco-tile at a mass ratio of about 1:4, respectively.

A portion of the at least two fine aggregates can comprise MSD. In certain embodiments, between 1-60% by weight, 5-60% by weight, 10-60% by weight, 10-55% by weight, 10-50% by weight, 15-50% by weight, 15-45% by weight, 20-45% by weight, or 20-40% by weight of the at least two fine aggregates comprise MSD. In certain embodiments, about 20% by weight or about 40% by weight of the at least one cement comprises MSD.

The eco-tile can comprise one or more superplasticizers. A superplasticizer can improve dispersion of the eco-concrete, so that less water is needed for good rheological properties, i.e. the ability to spread the coating in a thin, even layer prior to curing. In certain embodiments, the cementitious coating composition comprises one or more superplasticizer selected from a poly(melamine sulfonate), a poly(naphthalene sulfonate), a polycarboxylate, a diphosphonate terminated polyoxyethylene, salts thereof and derivatives thereof, and combinations of the foregoing. Exemplary superplasticizers include, but are not limited to, poly(ethyleneoxide)-grafted polyacid species, sodium salts of poly(melamine sulfonate), poly(naphthalene sulfonate), and polycarboxylates and sodium naphthalene sulfonate formaldehyde. In certain embodiments, the superplasticizer is a polycarboxylate sold by BASF™ under the trademark ADVA® 109.

The one or more superplasticizers can be present in the eco-tile at 0<1 wt %. In certain embodiments, the one or more superplasticizers is present in the eco-tile at 0.01-1 wt %, 0.01-0.9 wt %, 0.01-0.8 wt %, 0.01-0.7 wt %, 0.01-0.6 wt %, 0.01-0.5 wt %, 0.01-0.4 wt %, 0.01-0.3 wt %, 0.01-0.2 wt %, 0.01-0.1 wt %, 0.01-0.09 wt %, 0.02-0.09 wt %, 0.03-0.09 wt %, 0.04-0.09 wt %, 0.04-0.08 wt %, 0.05-0.08 wt %, 0.05-0.07 wt %, or 0.055-0.07 wt %. In certain embodiments, the about 0.057 wt % or about 0.066 wt %.

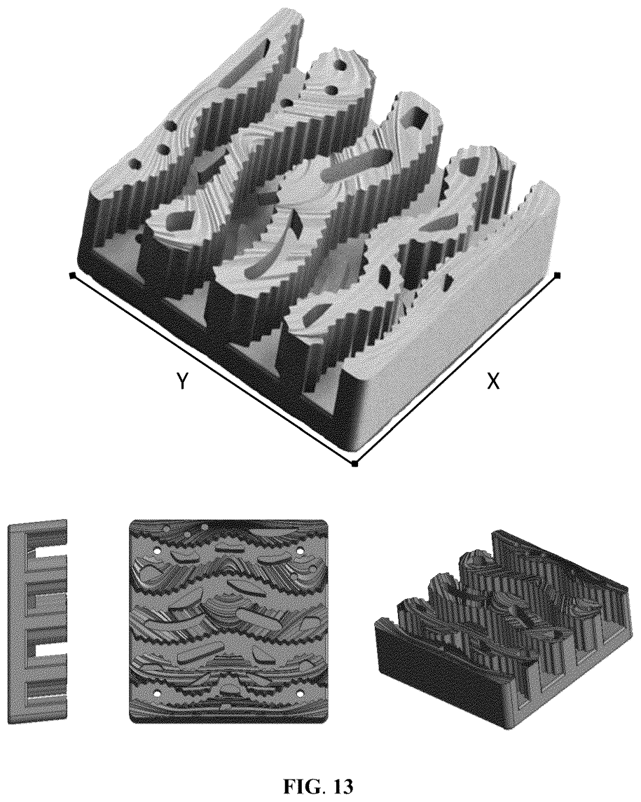

One or more surfaces of the eco-tile can be defined by a plurality of microhabitat forming features selected from the group consisting of crevices, fissures, tunnels, holes, and irregular surface features of the eco-tile surface. FIG. 13 depicts an exemplary eco-tile comprising a surface comprising crevices, fissures, tunnels, holes, and irregular surface features.

The surface of the eco-tile descripted herein can have a pH which promotes the recruitment and growth of fauna and flora on the eco-tile surface. In certain embodiments, a surface of the eco-tile can have a pH below 11, below 10, below 9, below 8, or about 7. In certain embodiments, the pH of the eco-tile can range from about 9 to about 10.5.

The eco-tiles described herein can exhibit high compressive strength, which can increase their lifetime in aquatic conditions. In certain embodiments, the compressive strength of the eco-tile is between about 35 to about 45 Mpa or about 33 to about 43.5 Mpa.

The present disclosure also provides a method of promoting the growth of fauna and flora in an aquatic environment comprising placing at least one eco-tile described herein in the aquatic environment.

Promoting the growth of fauna and flora can comprise the recruitment of at least 1 species, at least 5 species, at least 10 species, at least 15 species, at least 20 species, at least 25 species, at least 30 species, at least 35 species, at least 40 species, at least 45 species, or at least 50 species per 25 cm×25 cm area of eco-tile (calculated by multiplying length (Y) and width (X) as shown in FIG. 13) after 12 months of deployment in the aquatic environment. In certain embodiments, promoting the growth of fauna and flora can comprise the recruitment of 1-50 species, 5-50 species, 10-50 species, 10-45 species, 15-45 species, 15-40 species, or 16-35 species per area (25 cm×25 cm) of eco-tile after 12 months of deployment in the aquatic environment. In certain embodiments, promoting the growth of fauna and flora can comprise the recruitment of about 16 to about 35 species per area (25 cm×25 cm) of eco-tile after 12 months of deployment in the aquatic environment. In certain embodiments, the fauna and flora that grow on the eco-tiles comprises one or more of algae, bivalves, polychaetes, gastropods, corals, tunicates, and crustaceans.

Also provided herein is an eco-concrete mixture useful for preparing the eco-tiles described herein. In certain embodiments, the eco-concrete comprises at least one type of cement; aggregates comprising at least two fine aggregates and coarse aggregates; at least one superplasticizer; MISSA; and water, wherein the at least two fine aggregates comprise MSD.

In certain embodiments, the eco-concrete mixture comprises ordinary Portland cement, MSD, sand, gravel, water, and the at least one superplasticizer selected from the group consisting of a poly(melamine sulfonate), a poly(naphthalene sulfonate), polycarboxylate, and a diphosphonate terminated polyoxyethylene.

The eco-concrete mixture can comprise the at least one cement at a concentration of 5-50 wt %, 10-50 wt %, 10-40 wt %, 10-35 wt %, 10-30 wt %, 10-25 wt %, 10-20 wt %, 11-19 wt %, 12-18 wt %, 12-17 wt %, 12-16 wt %, 13-16 wt %, or 13-15 wt %. In certain embodiments, the eco-concrete mixture can comprise the at least one cement at a concentration of about 14 wt %.

The eco-concrete mixture can comprise MISSA at a concentration of 1-10 wt %, 2-10 wt %, 1-9 wt %, 2-9 wt %, 1-8 wt %, 2-8 wt %, 1-7 wt %, 2-7 wt %, 1-6 wt %, 2-6 wt %, 1-5 wt %, 2-5 wt %, 1-4 wt %, 2-4 wt %, 1-3.5 wt %, 2-3.5 wt %, 1.5-3.5 wt %, 2.5-3.5 wt %, or 3.0-3.5 wt %. In certain embodiments, the eco-concrete mixture can comprise MISSA at a concentration of about 3.3 wt %.

The eco-concrete mixture can comprise the coarse aggregate at a concentration of 20-60 wt %, 25-60 wt %, 30-60 wt %, 30-55 wt %, 30-50 wt %, 30-45 wt %, or 35-45 wt %. In certain embodiments, the eco-concrete mixture can comprise the coarse aggregate at a concentration of about 40%.

The eco-concrete mixture can comprise the at least two fine aggregates excluding the weight of the MSD at a concentration of 15-40 wt %, 20-40 wt %, 20-35 wt %, 20-30 wt %, 25-30 wt %, 15-35 wt %, 15-30 wt %, or 15-25 wt %. In certain embodiments, the eco-concrete mixture can comprise the at least two fine aggregates excluding the weight of the MSD at a concentration of about 20 wt % to about 27.4 wt %.

The eco-concrete mixture can comprise the MSD at a concentration of 1-30 wt %, 1-25 wt %, 1-20 wt %, 5-20 wt %, or 5-15 wt %. In certain embodiments, the eco-concrete mixture can comprise the MSD at a concentration of about 6.9 wt % to about 13.7 wt %.

The eco-concrete mixture can comprise the at least one superplasticizer at a concentration of about 0.01-1.0 wt %, 0.01-0.9 wt %, 0.01-0.8 wt %, 0.01-0.7 wt %, 0.01-0.6 wt %, 0.01-0.5 wt %, 0.01-0.4 wt %, 0.01-0.3 wt %, 0.01-0.2 wt %, 0.01-0.1 wt %, 0.01-0.09 wt %, 0.01-0.08 wt %, 0.02-0.08 wt %, 0.03-0.08 wt %, 0.03-0.07 wt %, 0.04-0.07 wt %, or 0.05-0.07 wt %. In certain embodiments, the eco-concrete mixture can comprise the at least one superplasticizer at a concentration of about 0.052 wt % to about 0.061 wt %.

The eco-concrete mixture can comprise water at a concentration of 5-20 wt %, 5-15 wt %, 5-10 wt %, 6-9 wt %, or 8-9 wt %. In certain embodiments, the eco-concrete mixture can comprise water at a concentration of about 8.5 wt %.

The eco-tiles described herein can be fabricated from the eco-concrete described herein using conventional methods well known to those of ordinary skill in the art. In certain embodiments, the eco-concrete is added to a mould and cured. The mould can optionally comprise one or more surfaces comprising crevices, fissures, tunnels, holes, irregular surface features, or a combination thereof. Curing can comprise allowing the eco-concrete to set at room temperature. Curing can also comprise the application of heat and/or reduced pressure to the eco-concrete. In certain embodiments, curing comprises allowing the eco-concrete. Curing can optionally be conducted in the presence of CO₂, which can result in a decrease in the pH of the surface of the thus formed eco-tile and/or the compressive strength of the eco-tile.

In certain embodiments, curing comprises exposing the eco-concrete to air for 1-21, 1-14, 7-14, or 5-10 days. In certain embodiments, curing can further comprise exposing the eco-concrete to an atmosphere comprising CO₂ for 1-5 days, 1-4 days, or 1-3 days.

The eco-concrete mixture can be made with milled incineration sewage sludge ashes (MISSA) to partially replace ordinary Portland cement (OPC) and combined with fine aggregates (river sand) (≤5 mm), coarse aggregate (crushed natural granite) (5-10 mm), and dredged marine sediment (MSD). Marine sediment can be used to partially substitute fine aggregates (Table 1). At least 20% of the OPC can be replaced with MISSA, and 20-40% of the fine aggregates are replaced with dredged marine sediment (Table 1). The amount of MISSA and MSD can vary according to the engineering requirements.

TABLE 1
Composition of eco-concrete mixtures produced with milled incineration sewage sludge
ash (MISSA) as a replacement for ordinary Portland concrete (OPC), and marine sediment
(MSD) as replacement of fine aggregate. SP (a polycarboxylate high-range water reducer
sold By BASF ™ under the trademark ADVA ® 109) indicates a superplasticizer.

| | | | | | | | | | MSD to |
|---|---|---|---|---|---|---|---|---|---|
| | | | | | | | | | replace |
| | | | | | | | Fine | Coarse | fine |
| | | | | | Water/ | | Aggregate | Aggregate | aggregate |
| Sample | Composition | OPC | MISSA | Water | Cement | SP | (0-5 mm) | (5-10 mm) | (dried) |
| MISSA- | 20% | 336 | 84 | 210 | 0.5 | 1.3 | 680 | 997 | 170 |
| 1 | MISSA + 20% | | | | | | | | |
| | MSD | | | | | | | | |
| MISSA- | 20% | 336 | 84 | 210 | 0.5 | 1.5 | 510 | 997 | 340 |
| 2 | MISSA + 40% | | | | | | | | |
| | MSD | | | | | | | | |

The eco-concrete mixture with MISSA and MSD can be cured under different combinations of air, steam, and CO₂ to increase the compressive strength and reduce the surface pH. CO₂ curing is conducted in a carbonation chamber at 1 bar to further reduce surface pH below 10.5 (Table 2).

TABLE 2
Curing conditions, compressive strength and surface pH of concrete mixtures produced
with milled incineration sewage sludge ash (MISSA) as a replacement for ordinary
Portland concrete (OPC), and marine sediment (MSD) as replacement of fine aggregate.
CO2 curing was conducted in a carbonation chamber at 1 bar.

| | | | Compressive | |
|---|---|---|---|---|
| | | | strength | |
| Sample | Composition | Curing conditions | (Mpa) | pH |
| MISSA-1A | 20% MISSA + | Air curing for 7 days and then | 39.11 ± 2.04 | 10.03 ± 0.33 |
| | 20% MSD | CO2 curing at 1 bar for 1 day | | |
| MISSA-2A | 20% MISSA + | Air curing for 7 days and then | 41.95 ± 3.89 | 9.95 ± 0.27 |
| | 40% MSD | CO2 curing at 1 bar for 1 day | | |
| MISSA-2B | 20% MISSA + | Air curing for 7 days and then | 43.55 ± 4.81 | 9.23 ± 0.15 |
| | 40% MSD | CO2 curing at 1 bar for 3 days | | |

The design of a eco-tile that has been tested for enhancing marine biodiversity on vertical concrete seawalls is described herein. The eco-tile comprising the eco-concrete described herein provides an appropriate substratum for the recruitment and growth of marine species, such as. The eco-concrete mixture is suitable for casting using various metal, plywood, plastic and silicone moulds. Thus, the eco-concrete can also be used to fabricate various concrete structures to enhance the biodiversity of different aquatic ecosystems. These concrete structures can take the form of tiles and panels to retrofit vertical seawalls, or blocks, armours and tidal pools (i.e., basins) to enhance sloping seawalls. The eco-concrete can also be used to build artificial subtidal reefs and to enhance artificial freshwater habitats.

The eco-tiles can be easily fixed onto existing and future seawalls and breakwaters. The eco-tiles can be fabricated using silicone moulds with a variety of features that include surface texture, tilted ridges, flat cool surfaces, crevices and holes (FIG. 13) to promote the recruitment and growth of marine species. The tilted ridges increase the surface area and provide shading, shelter and water retention to reduce heat and desiccation stress for intertidal species. The ridges protrude ˜5 cm with an inclination angle of 7°. The crevices formed between the ridges provide a shaded and cool surface. The surface texture of the tile is achieved with a combination of grooves of variable sizes that can range from fine grooves (i.e., fine texture) of 1 mm wide and 1 mm deep to thicker grooves (rough texture) of 5 mm wide and 5 mm deep. The surface texture facilitates the recruitment of invertebrate propagules. The tile also provides flat surfaces to allow herbivore gastropods to graze on biofilm and algae. The tile is ornamented with holes and extrusions of variable shapes and sizes to provide cooler shelters and predation refuge for small animals. Combining these features increases the heterogeneity of microhabitats for promoting and enhancing the recruitment and growth of diverse marine species.

### EXAMPLES

In accordance with Table 1, all constituents of the concrete were first mixed in a pan mixer. Workable fresh concrete mixtures were then obtained and cast in the designed silicone moulds with specific features.

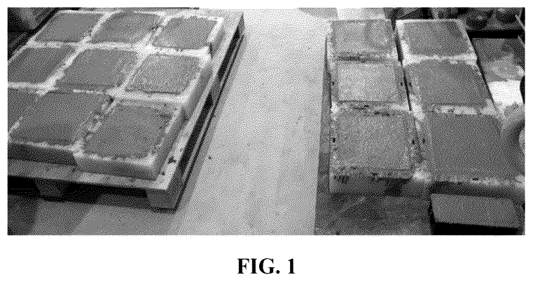

The finish of the cast Eco-concrete tiles is shown in FIG. 1.

After air curing for one day r, all eco-concrete tiles were demoulded and continually cured according to the curing conditions in Table 2.

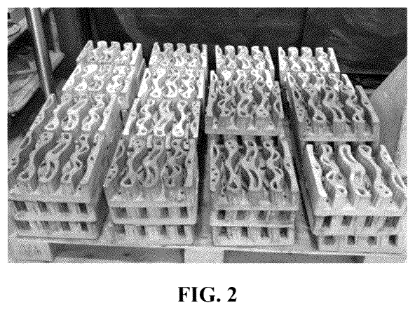

The final eco-concrete tiles are shown in FIG. 2.

In accordance with the preparing procedures described above, the compressive strength and surface pH of the concrete mixtures are listed in Table 2.

Preliminary engineering analyses were conducted on Sai Kung's eco-tiles after 12 months of deployment. Such analyses were conducted at the Department of Civil and Environmental Engineering at The Hong Kong Polytechnic University.

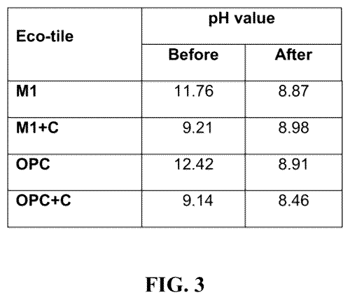

FIG. 3 shows the pH values for the concrete surface of the eco-tiles before and after deployment. Measurement was conducted with a Extech ExStik pH meter with a flat surface electrode. The results showed that pH on all eco-tiles decreased from 9.14-12.42 to 8.46-8.98 after 12 months in the sea (in particular surface pH of OPC eco-tiles without carbonation reducing from 12.42 to 8.91), suggesting that there was natural neutralisation of the surface pH of the eco-features. The current results also imply that lowering surface pH on eco-shoreline features may not be needed for mid- and long-term deployment.

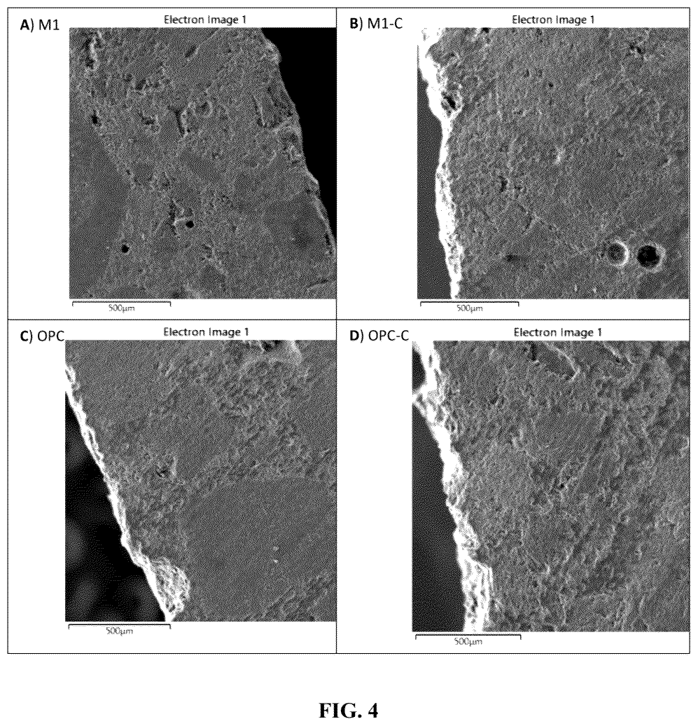

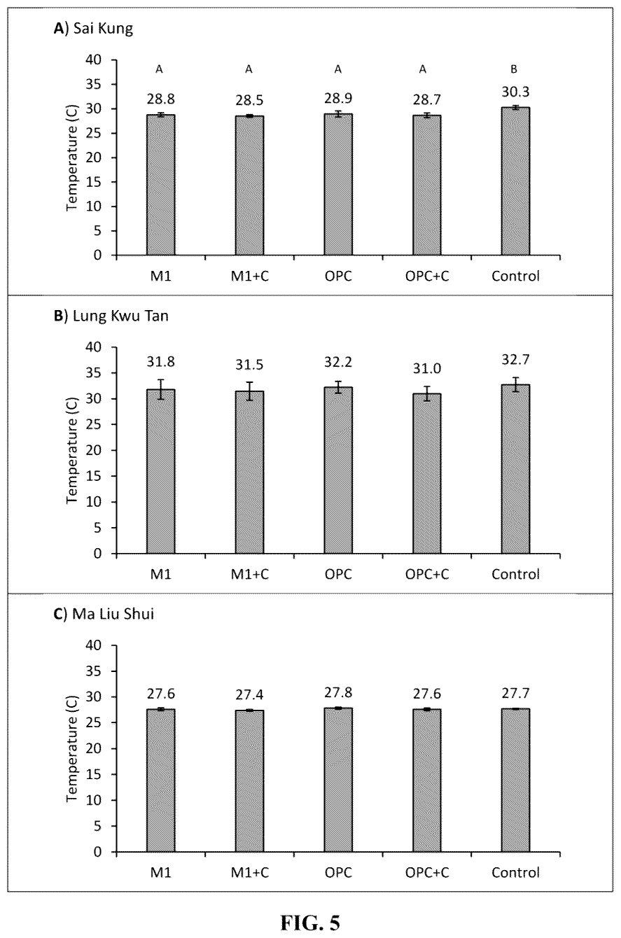

Scanning electron microscope (SEM) analysis was conducted on the eco-tiles with a Tescan VEGA 3 apparatus. The morphologies of the concrete samples (FIG. 4) indicated that the material structures of the eco-tiles were still in good condition (i.e., damage was not observed) after 12 months of deployment.

At the Sai Kung trial site, temperatures of the different types of eco-tiles were significantly lower than the temperature of the seawall control plot (F_{4,15}=8.708, P<0.001, FIG. 5). However, no significant differences in temperatures were found among the eco-tile types (FIG. 5). Eco-tiles were about 1-2° C. lower than the seawall control plots on average (FIG. 5).

At the Lung Kwu Tan trial site, temperatures of the eco-tiles and the control plot were not significantly different (F_{4,15}=8.708, P<0.001, FIG. 5).

At the Ma Liu Shui trial site, temperatures of the eco-tiles and the control plot were not significantly different (F_{4,15}=1.933.708, P<0.001, FIG. 5).

The lack of difference between eco-tiles and the control plots at Lung Kwu Tan and Ma Liu Shui might be due to the season and the time at which the surveys were conducted (i.e., May). Due to the orientation of the seawall and surveying time, the eco-tiles and the control plots were mostly shaded when the temperature was measured. At Lung Kwu Tan, also large waves and splashes (mainly caused by marine traffic) could have lowered the surface temperature of the eco-tile and the control plot, affecting the thermo images recording. Marked differences should be therefore found when the eco-tiles were exposed directly to the sun in extended low tides.

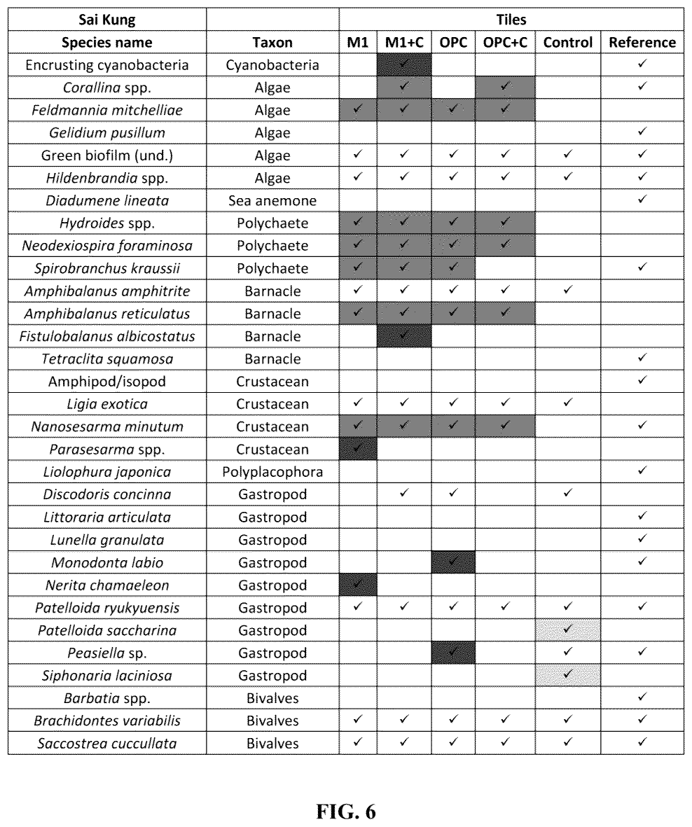

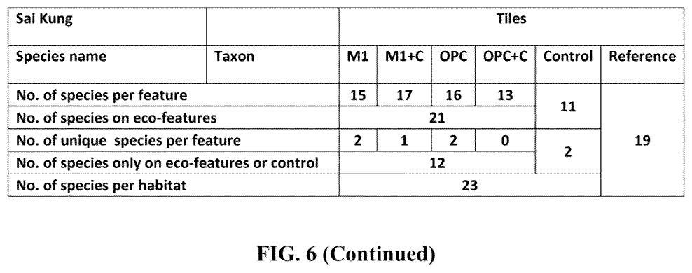

At Sai Kung, a total of 31 species were recorded on the eco-tiles, control and reference plots (FIG. 6). At the trial site, 23 species were encountered. M1, M1+C, OPC and OPC+C tiles had 15, 17, 16 and 13 species recorded respectively, while 11 species were recorded on the control seawalls. A total of 19 species were recorded at the rocky shore reference site scraped plots. Twelve species appeared only on the eco-tiles.

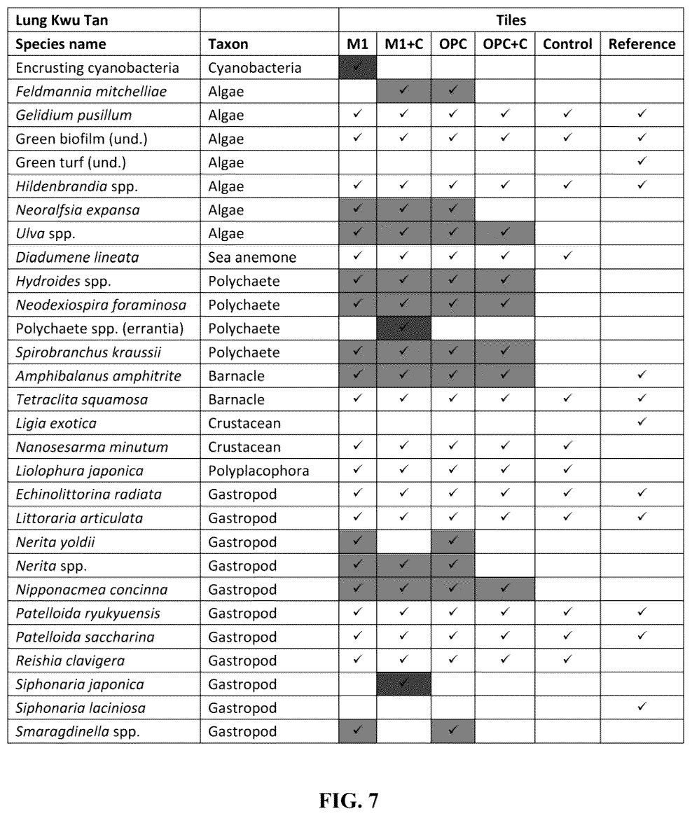

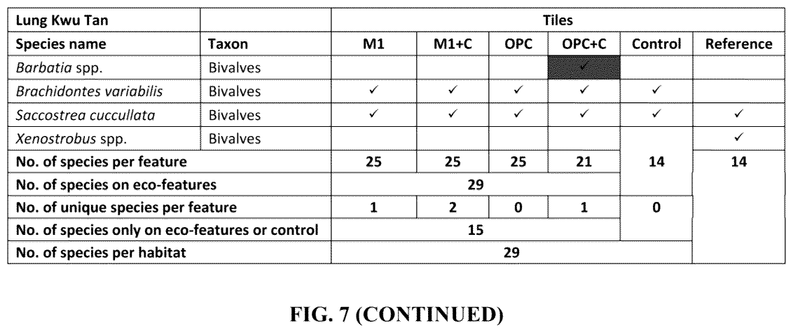

In Lung Kwu Tan, 33 species were recorded on the eco-tiles, control plots and reference site (FIG. 7). At the trial site, 29 species were encountered, of which 25 species were found on M1, M1+C and OPC tiles, 21 species on OPC+C tiles, and 14 species on control plots. A total of 14 species were recorded at the rocky shore reference site scraped plots. Fifteen species were found only on the eco-tiles.

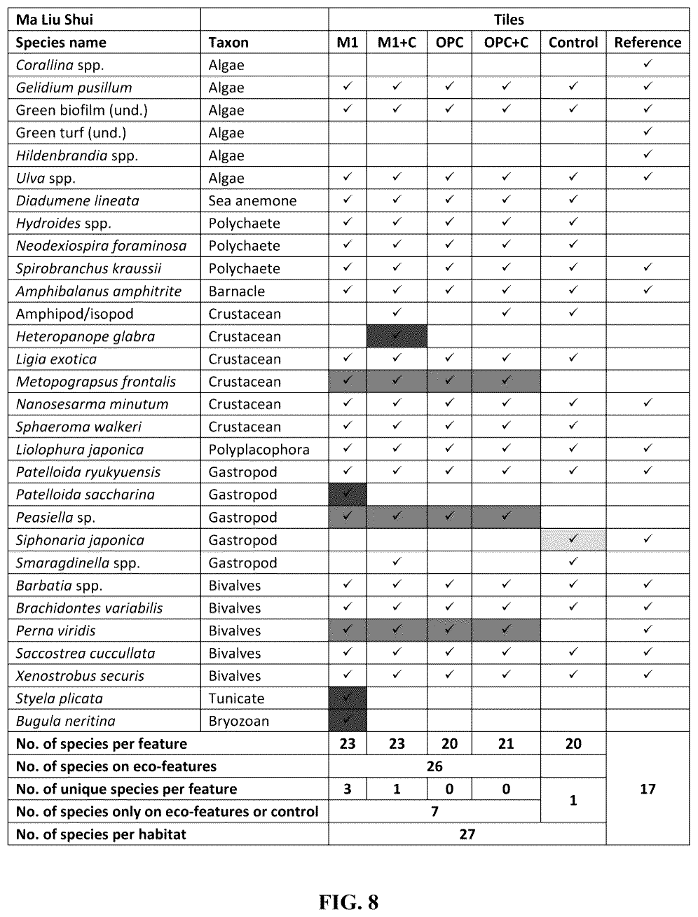

In Ma Liu Shui, 30 species were recorded on the eco-tiles, control plots and reference site (FIG. 8). At the trial site, 27 species were encountered. For the eco-tiles, 23 species were found on M1 and M1+C tiles, 20 species on OPC and control plots, and 21 species on OPC+C tiles. A total of 17 species were recorded at the rocky shore reference site scraped plots. Seven species appeared only on the eco-tiles.

In Sai Kung the mean species richness on eco-tiles was significantly higher than that on seawall control plots (F_{4,15}=16.993, P<0.001, FIG. 5). The mean species richness on eco-tile types ranged between 11.0 and 12.5 and there were not significant differences among them (FIG. 5). The mean species richness on control plots was of 6.8 species.

In Lung Kwu Tan the mean species richness on eco-tiles was significantly higher than that on seawall control plots (F_{4,15}=21.355, P<0.001, FIG. 5), but there were no significant differences among types of eco-tiles (FIG. 5). The mean species richness on control plots was of 8.5 species, while that on eco-tiles ranged between 11.0 and 12.5 species.

In Ma Liu Shui the mean species richness on eco-tiles and control plots was not significantly different (F_{4,15}=1.985, P=0.149, FIG. 5). However, the mean number of species on eco-tiles tended to be higher on eco-tiles in comparison to seawall control plots. Mean species richness on control plots was of 15.5 species and on eco-tiles it ranged between 16.8 and 19.0 species.

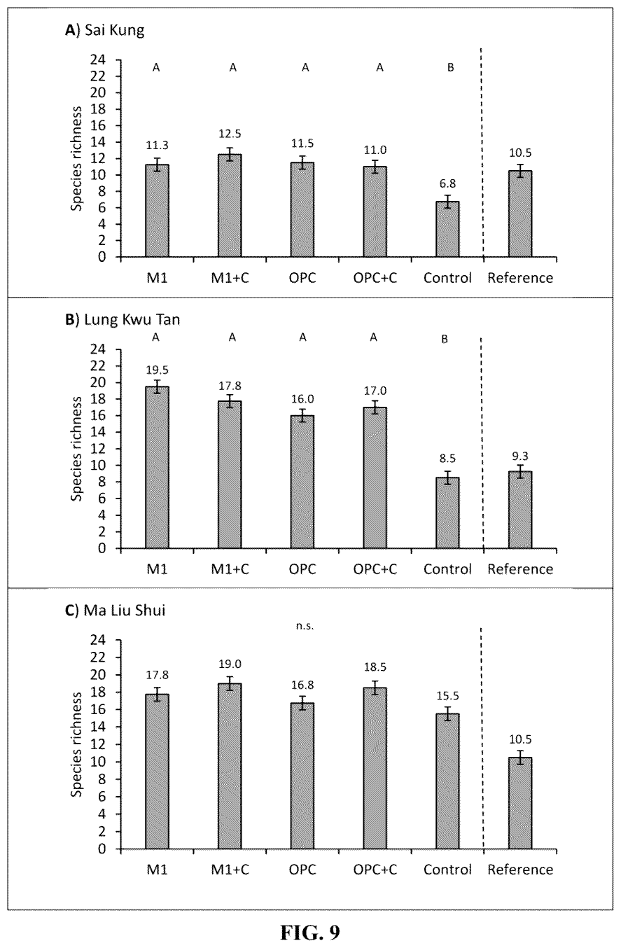

In Sai Kung, most of the eco-tiles had significantly higher mean number of mobile species than the seawall control plot (F_{4,15}=5.385, P=0.007, FIG. 9). The most abundant mobile species recorded on eco-tiles and control plots were the scavenger isopod Ligia exotica, followed by the herbivore limpet Patelloida ryukyuensis (FIG. 9). The scavenger crab Nanosesarma minutum was only common on eco-tiles but not on control plots (FIG. 9). Therefore, scavenger and herbivore were the most common mobile species on eco-tiles (FIG. 9).

In Lung Kwu Tan, eco-tiles had higher mean number of mobile species than the control plots (F_{4,15}=3.724, P=0.027), but this difference was only significant for eco-tile M1 (FIG. 9). The limpets Patelloida ryukyuensis, P. saccharina and the snail Littoraria articulata contributed to the high abundance of herbivore in Lung Kwu Tan (FIG. 9). The scavenger crab Nanosesarma minutum and the carnivore whelk Reishia clavigera were also common on eco-tiles but not on control plots (FIG. 9).

In Ma Liu Shui, there was a trend of higher mean number of mobile species on the eco-tiles in comparison to the seawall control plot, however, this difference was not statistically significant (F_{4,15}=0.610, P=0.662). The most common mobile species across the eco-tiles and control plots were the herbivore limpet Patelloida ryukyuensis, followed by the scavenger crab Nanosersarma minutum and isopod Ligia exotica (FIG. 9).

In general, all eco-tiles tended to have higher abundance of mobile species than the control and reference plots in all three sites (FIG. 9). Limpets, crabs and isopods were the taxa that benefited the most on the eco-tiles. Differences among eco-tiles were not noticeable, suggesting that the increase in abundance was mainly caused by the design and microhabitats of the eco-tiles rather than the concrete mixture of the tiles (FIG. 9). Our results also indicated that there was great variation between replicates of the same feature, resulting in large error bars. This variation may have hindered the detection of significant differences between eco-tiles and control plots at Ma Liu Shui, and increased sample sizes (i.e., more eco -tiles per treatment) would be required in future studies.

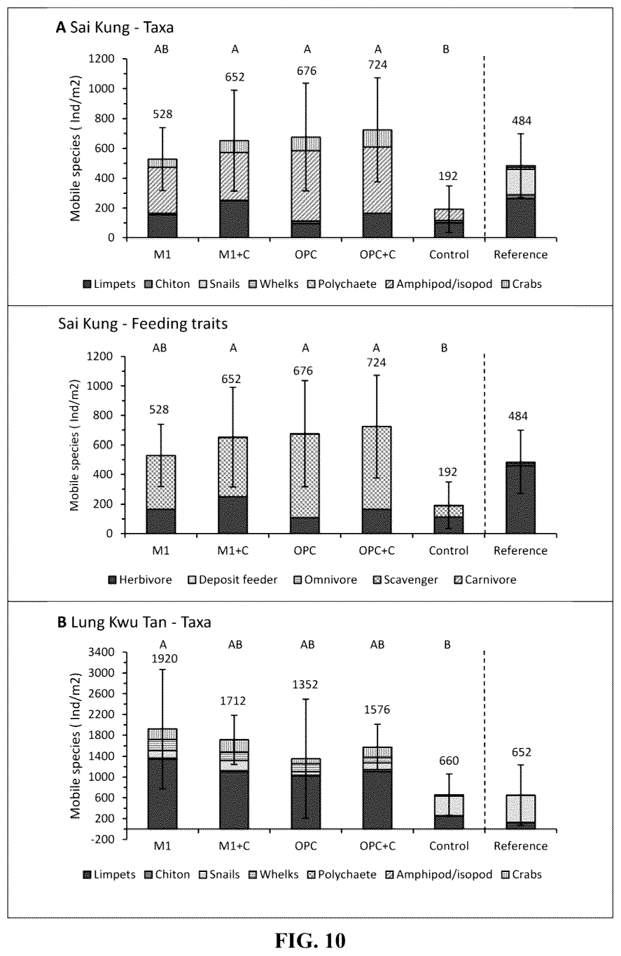

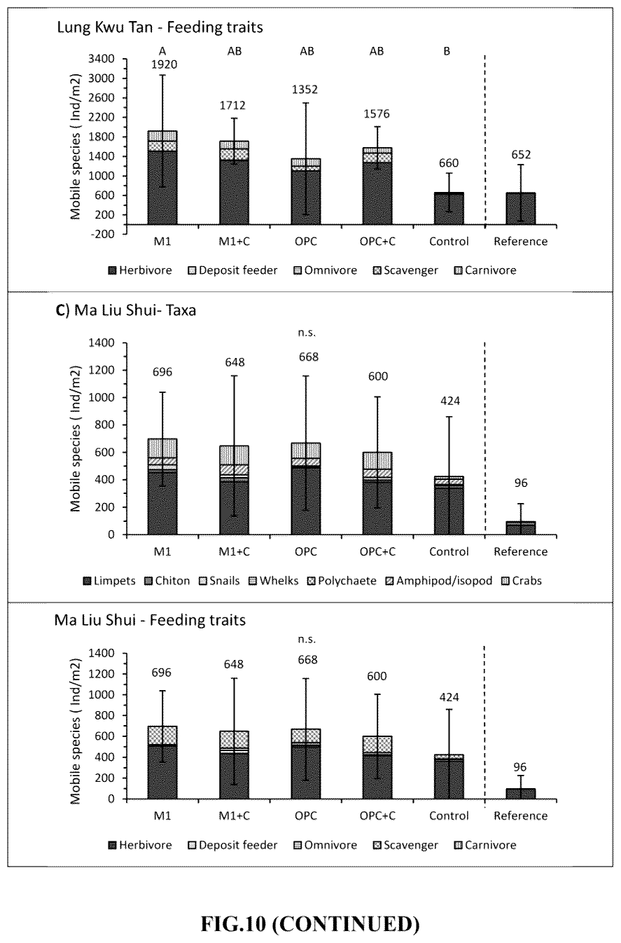

Overall percentage coverages of epibiota on the eco-tiles, control plots and reference plots were close to 100% at all three sites. Part of the coverage was represented by algae (including biofilm), which are common on seawalls (FIG. 10). Therefore, to determine the contribution of the eco-tiles to the enhancement of the intertidal community, the analysis should focus on the fauna coverage in the future (i.e., sessile invertebrates, FIG. 10).

In Sai Kung the coverage of sessile invertebrates was significantly higher on eco-tiles than on control plots (F_{4,15}=14.991, P<0.001, FIG. 10). The higher coverage on eco-tiles was mainly caused by higher abundance of barnacles and bivalves (FIG. 10) Eco-tile M1 and M1+C doubled the invertebrate coverage found on control plots (FIG. 10).

In Lung Kwu Tan, the percentage coverage of sessile invertebrates on the eco-tiles and control plots was not significantly different (F_{4,15}=1.178, P=0.360). Overall, the coverage ranged between 51% and 64% with a slightly higher coverage on the control plot (FIG. 10). The abundance of sessile invertebrates was dominated by bivalve species, followed by barnacles (FIG. 10). The lack of differences in Lung Kwu Tan, could be caused by some oyster shells that remained on the seawall control plots at the commencement of the trial, providing microhabitats for the development of the community. The initial cleaning of the seawall control plot was difficulted by strong wave actions.

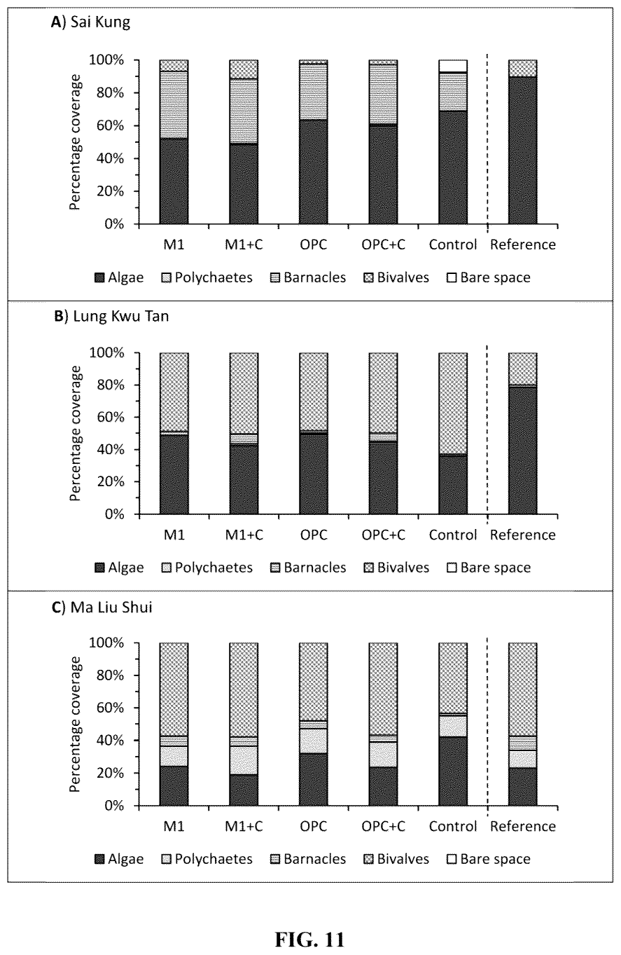

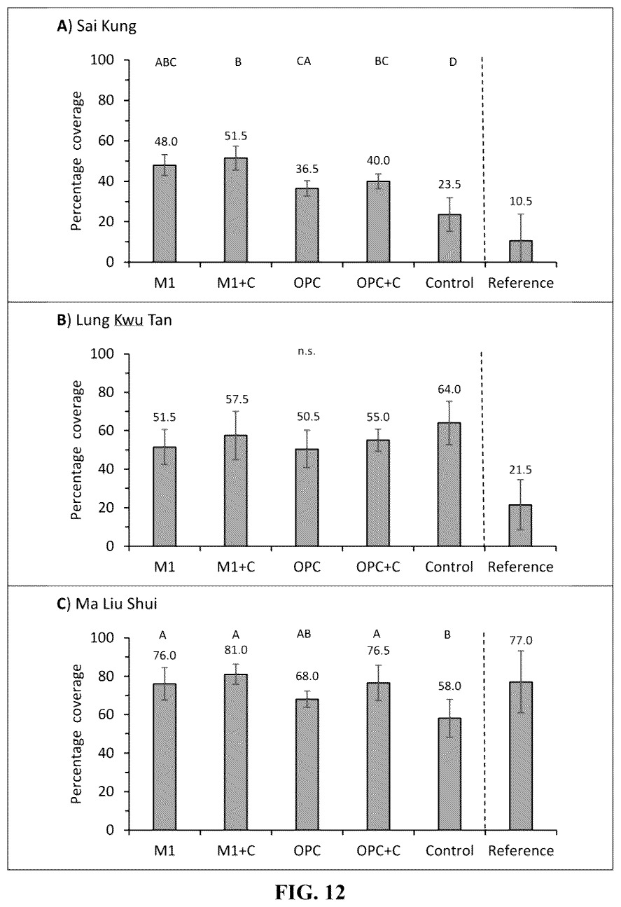

In Ma Liu Shui, the percentage coverage of sessile invertebrates on the eco -tiles was significantly higher than the coverage on the control plots (F_{4,15}=5.420, P=0.007, FIG. 11), except for eco-tile OPC that was not significantly different (FIG. 11). Overall, sessile invertebrate coverage ranged between 58% and 81% with bivalves as the most dominant group, followed by polychaetes (FIG. 11).

The percentage coverage showed that the eco-tiles promoted the recruitment and survival of sessile invertebrates like bivalve, barnacles and polychaetes in Sai Kung and Ma Liu Shui. Overall, differences among eco-tiles with different concrete mixtures and pH were not consistent, indicating that the design and microhabitats of the eco-tiles may be more relevant in enhancing sessile communities than the composition of the concrete mixture. The increase of sessile species like bivalves and barnacles may further contribute to an increase of biodiversity (Bradford et. al., 2020).

In general, the eco-tiles tended to have higher mean species richness, abundance of mobile species and coverage of sessile invertebrates when compared with that of the control plots (FIGS. 8-11). Species richness and mobile species abundance were consistently higher on eco-tiles in Sai Kung and Lung Kwu Tan, while coverage of sessile invertebrates was higher on the eco-tiles at Sai Kung and Ma Liu Shui.

Based on the results, there were no apparent differences between M1 and M1+C with low pH, or between OPC and OPC+C with low pH. As observed in the engineering analysis, the pH of all eco-tiles decreased to below 9.0 after one year of deployment. This suggests that there was natural neutralisation of surface pH of the eco-features, and pH might not be an important controlling factor for the development of intertidal communities on concrete surfaces in sub-tropical Hong Kong. Similarly, the use of recycled MISSA and dredged marine sediment in eco-tiles showed to be suitable for the recruitment and growth of marine organisms. Thus, the use of recycled waste material in concrete mixture with normal pH can become a feasible alternative to produce eco-shoreline features with a lower carbon footprint.

What is claimed is:

1. An eco-tile comprising:
at least one type of cement;
aggregates comprising at least two fine aggregates and coarse aggregates; and
milled incineration sewage sludge ashes (MISSA), wherein the at least two fine aggregates comprise dredged marine sediment (MSD).

2. The eco-tile of claim 1, wherein a surface of the eco-tile has a pH less than 11.

3. The eco-tile of claim 1, wherein a surface of the eco-tile has a pH between 9-10.5.

4. The eco-tile of claim 1, wherein the eco-tile has a compressive strength 35-45 Mpa.

5. The eco-tile of claim 1, wherein the at least one type of Type I Ordinary Portland Cement, Type II Modified or Blended Portland Cement, Type III Rapid Hardening Portland Cement, Type IV Low Heat Portland Cement, Type V, Sulphate-Resisting Portland Cement, or a combination thereof.

6. The eco-tile of claim 1, wherein the at least two fine aggregates comprise sand.

7. The eco-tile of claim 1, wherein the coarse aggregates comprise gravel.

8. The eco-tile of claim 1, wherein the MISSA and the at least one type of cement are present in the eco-tile at a mass ratio of at least 1:4, respectively.

9. The eco-tile of claim 1, wherein the MSD and each of the other fine aggregates present in the at least two fine aggregates are present in the eco-tile at a mass ratio of at least 1:4, respectively.

10. The eco-tile of claim 1, wherein the MSD and each of the other fine aggregates present in the at least two fine aggregates are present in the eco-tile at a mass ratio of 1:4 to 2:3, respectively.

11. The eco-tile of claim 1, further comprising at least one superplasticizer selected from the group consisting of a poly(melamine sulfonate), a poly(naphthalene sulfonate), polycarboxylate, a diphosphonate terminated polyoxyethylene, and salts thereof.

12. The eco-tile of claim 1, wherein at least one surface of the eco-tile is defined by a plurality of microhabitat forming features selected from the group consisting of crevices, fissures, tunnels, holes, and irregular surface features of the eco-tile surface.

13. The eco-tile of claim 1, wherein the eco-tile comprises:
ordinary Portland cement;
aggregates comprising MSD, sand, and gravel;
MISSA; and
at least one superplasticizer selected from the group consisting of a poly(melamine sulfonate), a poly(naphthalene sulfonate), polycarboxylate, a diphosphonate terminated polyoxyethylene, and salts thereof,
wherein the ordinary Portland cement and the MISSA are present in the eco-tile at a mass ratio of at least 1:4, respectively; the MSD and the sand are present in the eco-tile at a mass ratio of 1:4 to 2:3, respectively; and at least one surface of the eco-tile is defined by a plurality of microhabitat forming features selected from the group consisting of crevices, fissures, tunnels, holes, and irregular surface features of the eco-tile surface.

14. The eco-tile of claim 13, wherein a surface of the eco-tile has a pH between 9-10.5.

15. The eco-tile of claim 13, wherein the eco-tile has a compressive strength 35-45 Mpa.

16. A method of promoting the growth of fauna and flora in an aquatic environment comprising placing at least one eco-tile of claim 1 in the aquatic environment.

17. The method of claim 15, wherein promoting the growth of fauna and flora comprises the recruitment of 16 to 35 species per 25 cm×25 cm area of eco-tile after 12 months of deployment in the aquatic environment.

18. An eco-concrete mixture comprising:
at least one type of cement;
aggregates comprising at least two fine aggregates and coarse aggregates;
at least one superplasticizer;
milled incineration sewage sludge ashes (MISSA); and
water, wherein the at least two fine aggregates comprise dredged marine sediment (MSD).

19. The eco-concrete mixture of claim 18, wherein the at least one type of cement is ordinary Portland cement; the aggregates comprise MSD, sand, and gravel; and the at least one superplasticizer is selected from the group consisting of a poly(melamine sulfonate), a poly(naphthalene sulfonate), polycarboxylate, a diphosphonate terminated polyoxyethylene, and salts thereof.

20. The eco-concrete mixture of claim 19, wherein the ordinary Portland cement, MISSA, MSD, gravel, sand, at least one superplasticizer, and water are present in the eco-concrete mixture in a 10-20 wt %, 2-7 wt %, 5-20 wt %, 30-50 wt %, 20-30 wt %, 0.01-0.5 wt %, or 5-10 wt %, respectively.

21. The eco-concrete mixture of claim 19, wherein the ordinary Portland cement, MISSA, MSD, gravel, sand, at least one superplasticizer, and water are present in the eco-concrete mixture in a 12-16 wt %, 2-4 wt %, 6-14 wt %, 35-45 wt %, 20-27 wt %, 0.03-0.07 wt %, or 7-10 wt %, respectively.
